(19) United States
(12) Patent Application Publication
(10) Pub. No.: US 2020/0163346 A1
(43) Pub. Date: May 28, 2020

(54) DOMESTIC BAKING DEVICE AND OPERATING METHOD

(71) Applicant: Flatev AG, Zurich (CH)

(72) Inventors: Wolfgang Riessbeck, Landschlacht (CH); Simon Wäger, Amriswil (CH); Christof Zwahlen, Romanshorn (CH)

(73) Assignee: Flatev AG, Zürich (CH)

(21) Appl. No.: 16/498,588

(22) PCT Filed: Mar. 27, 2017
(86) PCT No.: PCT/EP2017/057179

§ 371 Date: Dec. 27, 2019

(51) Int. Cl. A21B 5/03; A21B 7/00

(52) U.S. Cl. CPC A21B 5/03; A21B 7/00

(57) ABSTRACT

A domestic baking device for baking a food product, in particular a flat bread, made of a dough portion which is first received in a portion capsule. The baking device includes a baking and pressing device (2) for baking and pressing the dough portion (3, 3′) between a first and a second baking plate (5). At least the first baking plate (4) can be driven relative to the second baking plate (5) along a preferably linear displacement path (s) towards the second baking plate (5) by means of adjusting means (7) which include an electric motor in order to flatten the dough portion (3, 3′) by pressing same between the baking plates (4, 5). The baking and shaping device (2) is paired with monitoring means in order to monitor the pressing process of the dough portion (3, 3′), including comparing means designed to monitor the curve of an electric motor signal (10), in particular a current or voltage signal, over the displacement path (s) of the first baking plate (4) in order to determine if a reference signal (9) that changes over the displacement path (s) of the first baking plate (4) has been reached or exceeded and to carry out an action if the reference signal (9) has been reached or exceeded.

### BACKGROUND OF THE INVENTION

The invention relates to a domestic baking device for baking a food product, in particular a flat bread, from a dough portion initially held in a portion capsule, the domestic baking device comprising a baking and pressing apparatus for baking and pressing (and thus deforming) the dough portion between a first and a second baking plate, at least the first baking plate being drivable relative to the second baking plate for a pressing flattening of the dough portion between the baking plates by means of movement means comprising an electrical motor (electric motor) along a preferably straight (translatory) movement path towards the second baking plate.

Additionally, the invention relates to a method (operating method)

for operating a domestic baking device, in particular a domestic baking device according to the invention, for baking a food product, in particular a flat bread, the first baking plate being moved respectively driven by the electrical motor (electric motor) for a pressing flattening of the dough portion disposed between the baking plates along the preferably straight (translatory) movement path towards the second baking plate, wherein the dough portion is preferably removed before from a capsule by means of a capsule-emptying apparatus of the domestic baking device.

From WO 2013/124809 A2, a domestic flat bread baking device is known in which a dough portion is removed from a portion capsule by a plunger applying force to the portion capsule. From the portion capsule, the dough portion arrives at an area between two baking plates, one of which is moved relative to the other baking plate by means of an electromotive drive in order to flat the dough portion, i.e. to form the flat bread. In order to ensure that a damage of components of the baking apparatus, in particular of the baking plates and/or the movement means, is avoided if the dough portion is not positioned exactly centrally, i.e. the force is applied eccentrically, a correspondingly massive and thus heavy and expensive mechanism is to be provided. In particular, it is necessary to provide correspondingly rigid guides to avoid a tilting of the baking plates relative to one another. The inadmissible provision of completely or partly frozen doughs or foreign matters into the known domestic baking device and starting of the pressing process may as well lead to damages of the baking plates and the movement means.

### SUMMARY OF THE INVENTION

Starting from the aforementioned state of the art, the object of the invention is to provide an improved domestic baking device which is characterized by movement means as filigree as possible for moving the first baking plate; however, damages of the baking plates and/or the movement means are reliably avoided in the case of eccentrically applied and/or too high forces. Further, the object is also to provide an accordingly improved operating method for operating such a domestic baking device.

Concerning the domestic baking device, said object is attained by the features disclosed herein, i.e., in a generic domestic baking device, by assigning monitoring means to the (combined) baking and forming apparatus for monitoring the pressing process of the dough portion, i.e. for monitoring the flattening or forming step, the monitoring means comprising comparing means which are designed to monitor a curve of an electrical motor signal (of the electric motor), in particular a current or voltage signal, over the movement path of the first baking plate for the reaching or exceeding of a reference signal, which changes (varies) over the movement path of the first baking plate, and to perform or to be designed to perform an action if the reference signal is reached or exceeded.

Concerning the method, the object is attained by the features disclosed herein, i.e. that in a generic method, a curve of an electrical motor signal (of the electric motor for driving the first baking plate along the movement path), in particular a current or voltage signal, over the movement path of the first baking plate is monitored for the reaching or exceeding of a reference signal, which changes (varies) over the movement path of the first baking plate, and that an action is performed if the reference signal is reached or exceeded.

Advantageous embodiments of the invention are disclosed herein and in the dependent claims. All combinations of at least two features disclosed in the description, the claims and/or the figures constitute part of the scope of the invention.

In order to avoid repetitions, disclosed features relating to the device are also seen as relating to the method and are thus also claimable therefor. In the same manner, disclosed features relating to the method are also seen as relating to the device and are thus also claimable therefor.

The idea of the invention is to press a dough portion which is emptied (removed) before from a portion capsule, preferably inside the domestic baking device, by means of a capsule-emptying apparatus or, alternatively, outside the domestic baking device, for example manually, between two baking plates and thus to flatten said dough portion into a flat bread or tortilla form, to detect an electrical motor signal, in particular a current or voltage signal, particularly preferably a current consumption signal of the electric motor for driving the first baking plate, and to compare it to a reference or limit value for the respective movement position of the first baking plate along the movement path towards the second baking plate. If the motor signal measured or provided by control means, in particular a motor signal level or value, is equal to or greater than the respective position-specific target or reference value, i.e. the reference signal assigned to the corresponding movement position of the first baking plate, an error or a hazard is detected and an action is performed, a visual and/or acoustic and/or haptic warning signal being output and/or the electric motor (electric motor) being actuated in such a manner that the movement of the first baking plate towards the second baking plate is stopped or slowed down and/or by moving or driving the first baking plate back to its initial position.

In other words, the domestic baking device according to the invention is realized and/or operated in such a manner that the pressing or flattening process of the dough portion is monitored with respect to improperly high forces, taking into account a comparing signal (reference signal) which changes over the movement path of the first baking plate. For that purpose, corresponding monitoring means comprising a microcontroller are provided, the monitoring means comprising comparing means configured to monitor a curve of the electrical motor signal of the electric motor, in particular a current or voltage signal, preferably a current consumption signal, over the movement path of the first baking plate for the reaching or exceeding of a reference signal changing over the movement path of the first baking plate and to perform an action if the reference signal is reached or exceeded. The invention is based on the realization that the signal height respectively level of the electrical motor signal, in particular of the current signal, defines the effective torque of the electric motor. If the torque of the electric motor increases, the motor signal (or the motor signal level), in particular the current consumption, also increases. If a force is exerted on or applied to the dough portion by the baking plates, in particular the first baking plate, during the pressing process in order to flatten or to form said dough portion, in particular into a flat bread such as a tortilla or a pizza, the torque of the motor also increases. As a result, the motor signal of the electric motor for driving the first baking plate also increases. Likewise, the torque and therefore the motor signal of the electric motor increase if the dough portion is not positioned exactly, in particular centrally under a force application point into the first baking plate, on the second baking plate, but said dough portion is, for example, disposed eccentrically with respect to a force vector along which a movement force is transmitted into the first baking plate, since a heavy load acts on the baking plates and the movement means because of the eccentric force transmission and the resulting torque.

Due to the assignment of reference signal levels, in particular maximum target current consumptions, to the positions of the first baking plate along its movement path, the reference signal levels can be defined at a lower value, because said reference signal levels do not have to correspond to the maximum reference signal level, in particular not with the maximum current consumption in the operating point. Due to the lower reference signal levels, in particular maximum nominal current consumption, there is also less resulting overload. Fewer overloads allow for a smaller dimensioning of the components involved in the pressing flattening of the dough and of a possible guidance of the first baking plate.

Relating to the invention, it is essential that the motor signal, i.e. a motor signal level, is not compared to a fixed or constant reference value, but that the current motor signal or a respective current motor signal level is compared to a reference signal dependent on the position of the first baking plate, i.e. to respective reference values changing over the movement path depending on the movement position of the first baking plate. The reference signal changes depending on the position or results from the torques to be expected at different movement positions of the first baking plate along the movement path and, therefore, from motor signals or motor signal levels during the pressing process and from safety factors. As an example, only low torques or motor signal levels, in particular current consumption levels of the electric motor, are expected during the movement of the first baking plate from an initial position to the first contact of the first baking plate with the dough portion, since only the frictional resistance of the system has to be overcome in this first movement section of the first baking plate along the movement path. If the motor signal (improperly) increases in this movement section and reaches or exceeds at least one limit or reference value assigned to this first movement section, it can be deduced that the driven components of the combined baking and pressing apparatus have met with (improper) resistance. Once the first baking plate has come into contact with the dough portion, the required movement force and thus the required motor torque and the motor signal, in particular a current consumption, increase. After the dough portion is partly compressed, for example by ⅔ of the initial vertical or height extension, the force increases significantly, in particular exponentially. The force path reaches a force maximum at a point at which the dough portion is pressed flat to a target height. The target height is preferably between 0.5 mm and 3 mm, in particular between 0.5 mm and 2 mm, more preferably between 0.8 mm and 1.5 mm, particularly preferably of approximately 1.2 mm. Typical values of such a force maximum are approximately 1000 N, but said values may vary depending on the desired target height and the composition of the dough.

Significantly higher forces are needed for the (improperly) flat pressing of still frozen or partly frozen dough portions. In this case, the force path significantly increases already at the beginning of the flat pressing, i.e. immediately after a contact of the first baking plate with the dough portion. If a thawed dough provided by the manufacturer is compressed by 5 mm, for example, an exemplary required or applied force is in a range from 25 N to 60 N. If, in comparison, a frozen dough is compressed by the identical movement path, the applied or required force is in a significantly higher range of, for example, approximately 1000 N. The monitoring means would detect said fact, because the motor signal increases improperly and exceeds a reference signal indicative of the movement section or of a corresponding movement position. Generally expressed an increasing torque and thus an increasing motor signal, in particular an increasing current consumption, is expected as of a contact of the first baking plate with the dough portion, which is characterized by an increased reference signal or reference values of this movement section, i.e. that the limit value to be exceeded from dough portion contact so that an error is detected and an action is performed, is higher than in a previously realized movement step,. As already mentioned, the reference signal, which is to be reached or exceeded in order to detect an error, increases along the movement path of the first baking plate towards the second baking plate.

In a preferred embodiment of the domestic baking device, the movement means comprise an, in particular single central transmission device, in particular a spindle drive (spindle-/spindle nut combination) which can be driven by the electric motor and said movement means move the first baking plate translatorically towards the second baking plate for pressing the dough portion. Thereby, the domestic baking device is preferably configured in such a manner that the dough portion is normally disposed centrally, i.e. centrically on the second baking plate, i.e. in such a manner that a virtual extension of the spindle and, therefore, of a force application vector passes through the dough portion, in particular centrically. In the case of a strongly eccentric arrangement, improperly high forces act and result in an improperly high movement-position-dependent motor signal which is detected by the monitoring means by comparing said motor signal to the position-dependent reference signal.

In a particularly preferred embodiment of the domestic baking device, the lateral guiding devices for guiding the first baking plate along the movement path during its movement are omitted. In other words, because of the design of the domestic baking device according to the invention it is not necessary and preferably not realized to provide such lateral guides guiding the first baking plate at its outer circumference, but the baking plate is preferably guided in a longitudinally moveable manner, if at all, in a central area, in particular about the spindle and/or the spindle nut. If guiding devices which act centrically and/or at the outer circumference of the first baking plate are provided, said guiding devices can be configured or realized in a smaller or more filigree manner at least because of the monitoring of the motor signal depending on the movement position according to the invention.

The baking apparatus of the domestic baking device according to the invention comprises both baking plates between which the dough portion is pressed and baked during and/or after the pressing process. During the baking process, the baking plates are preferably disposed in a baking chamber of the domestic baking device in a device housing. The dough portion is heated during the baking process, in particular to a temperature of more than 150° C., particularly preferably between 180° C. and 280° C. At least one of the baking plates, preferably both baking plates is/are preferably designed as a heating baking plate or baking plates having at least one heating, in particular an electrical resistance heating, i.e. having the function of a contact heating during the baking process. Additionally or alternatively, it is possible to heat the entire baking chamber for baking the flattened dough portion.

In regard to the specific realization of the comparing means or the comparison of the electric motor signal with a reference signal, different embodiments are available. It is generally possible to realize an analog comparison, in which the analog motor signal, in particular a current consumption signal, is directly compared to a reference signal generated in the device, in particular by means of a comparator circuit. A realization of digital comparing means is however preferred in which a large number of discrete values are compared to one another, i.e. a large number of electrical motor signals or levels are compared to corresponding reference signal levels or reference (limit) values, wherein preferably these reference signal levels, which together form the reference signal, are preferably stored in a memory as a table or mathematical function. The assigning of the motor signal levels with the corresponding reference signal levels, which are position-specific for the first baking plate, is preferably based on signals indicative of respective movement positions of the first baking plate along its movement path. In other words, during the monitoring or comparing, the monitoring means take into account a position of the first baking plate along the movement path by means of a signal indicative of the position via which a current or actual motor signal is assigned to a reference signal or reference signal level stored in a memory. The movement positions or a signal indicative of the movement position and the motor signal are preferably detected at any point during the movement and/or with a high frequency.

In regard to the sensing and/or forming of the signals indicative of the position, different possibilities are available. It is possible, for example, to directly detect the current position of the first baking plate along the movement path, for example by means of light barriers or magnetic coding, etc. In a preferred embodiment, the signals indicative of the position are identified by integrating rotation angles or rotations of a motor shaft of the electric motor or a rotating and/or pivoting unit coupled with the motor shaft of the electric motor to transmit the torque, in particular a gear wheel or a spindle (of a spindle drive) or a spindle nut (of a spindle drive) or a lever arm, in particular a toggle lever mechanism, so that the resulting position of the first baking plate is indirectly deduced by means of at least one moving component mechanically coupled with the first baking plate or by the detection of its partial movements and the integration thereof. Alternatively, it is also possible in principle to deduce the movement position of the baking plate along the movement path by means of a time measurement.

In a preferred manner, the monitoring means are preferably initialized in an initial position of the first baking plate by, for example, operating a switch, in particular a micro switch, directly or indirectly by moving the first baking plate. Alternatively, initialization can be realized by means of a corresponding sensor system, such as a light barrier or a similar sensor unit. It is also conceivable to realize initialization in such a manner that a moving element of the baking and pressing apparatus is moved against a mechanical stop and it is detected for example by measuring a current increase that the first baking plate is in a (defined or desired) initial position. The lower baking plate may also serve as mechanical stop for the initialization. It is essential, regardless of the type of initialization, that the position-indicative signal is determined from an initial position that can be defined by the initialization, in particular from a defined initial position.

In order to detect the rotation angles or numbers of rotation, a rotating component, such as the motor shaft of the electric motor or a gear wheel or a spindle of a spindle drive or spindle nut of a spindle drive or a lever, in particular a toggle lever, can have an assigned rotation angle encoder detecting the rotation angles and/or rotations of the said component from an initial position (initialization position).

It is generally possible to convert the detected rotations or rotation angles of the motor shaft or of another rotating or pivoting component into the movement path and thus a movement position of the first baking plate along the movement path using a known transmission by means of a circuit or software of the monitoring means. This step can also be omitted and the assignment of motor signal levels to reference signal levels can be performed directly via an integrated (added up) number of rotations or integrated (added up) angle of rotation.

In a particularly preferred embodiment of the domestic baking device, the first baking plate is moved along a straight movement path towards the second baking plate for pressing the dough portion. Irrespective of the specific embodiment of the movement path, which can also be realized in a curved manner, the second baking plate is preferably not driven towards the first baking plate for pressing the dough portion, said embodiment being an alternative possibility, i.e. that both the first baking plate and the second baking plate are driven and, therefore, both baking plates are actively moved towards one another. In this regard, it is possible to monitor solely the motor signal of the drive motor of the first baking plate. If a separate (second) electronic motor for moving the second baking plate is provided, said additional motor signal can be monitored in a similar manner. In a more preferred embodiment, both baking plates are actively driven by a common motor—in this case, solely the motor signal of said one (single) electric motor is to be monitored. As already mentioned, in a particularly preferred embodiment solely the first baking plate is actively driven towards the second baking plate being fixed when the dough is pressed for pressing the dough portion.

It is particularly advantageous if the first baking plate is disposed and remains parallel to the second baking plate when the dough is pressed. Irrespective of this, it is advantageous if the first baking plate, which is driven by the electrical motor, is disposed on a horizontal supporting surface above the second plate if the domestic baking device is supported according to the invention, i.e. the first baking plate is preferably displaced from above to below towards the second baking plate.

In a particularly preferred embodiment, the domestic baking device has a capsule-emptying apparatus for removing the dough portion from a portion capsule, but in principle, as already mentioned, also an embodiment without such an (integrated) emptying apparatus can be realized and the dough portion is removed for example manually from the portion capsule before the preparation of the food product by means of the domestic baking device outside the domestic baking device. The capsule-emptying apparatus comprises at least one force application element for applying force to, in particular deforming, the capsule. According to a first alternative realization variation, the use of a plunger which can be driven by means of an electric motor along the movement path, for example translatorically, as the force application element is provided for applying force to, in particular deforming, the portion capsule in order to remove the dough portion from the portion capsule. It is also possible to provide a holding-down stamp as a force application element, which can be or is moved relative to the portion capsule by means of an electric motor along the movement path, for applying force to the portion capsule, in particular at a radially projecting peripheral edge of the capsule on which, particularly preferably, a lid film of the portion capsule is sealed, in particular on a side turned away from the surface of the holding-down stamp. Force is applied to the capsule, for example by means of a translatory moving of the holding-down stamp along the movement path and the capsule is moved against a blade, in particular a ring blade of the domestic baking device in order to puncture a lid film of the portion capsule and thus to open the capsule and/or to move the capsule against a capsule support for a positioning of the portion capsule or it being held clamped between the holding-down stamp and the capsule support. It is generally possible to provide either a plunger or (i.e. alternatively) a holding-down stamp as the force application element. In a preferred embodiment, the domestic baking device comprises a plunger as well as a holding-down stamp both being movable by means of an electric motor. In this regard, it is possible to assign a respective (separate) electric motor to the plunger as well as to the holding-down stamp. In a particularly preferred embodiment, the plunger and the holding-down stamp can be or are moved by means of a common, in particular single electric motor and the plunger and the holding-down stamp are mechanically coupled in a dedicated manner. Irrespective of whether the plunger and the holding-down stamp can be moved by means of a common or separate electric motor along a movement path, it is preferred if they are arranged relatively to one another or operatively connected to one another, since the plunger and the holding-down stamp can be moved relatively to one another and relatively to the portion capsule or to a blade for puncturing the lid film of the capsule and/or the capsule support. In particularly preferred embodiments, the plunger is arranged in a holding-down stamp, which is preferably at least partly formed as a ring, the holding-down stamp, as described above, preferably interacting with a radially projecting peripheral edge of the portion capsule and the plunger, at the same time, acting preferably centrally on a portion capsule base of the tub-like portion capsule body, in particular made of plastic or light metal alloys, for deforming the tub-like body in order to remove the dough portion, particularly after the portion capsule was moved against a blade for puncturing a capsule lid film by means of a holding-down stamp and/or fixed being clamped between the holding-down stamp and a capsule support.

In a particularly preferred manner, the emptying process of the facultative capsule-emptying apparatus is monitored by analogy with the monitoring of the pressing process of the baking and pressing apparatus, i.e. by assigning monitoring means monitoring the emptying process of the dough portion to the emptying apparatus, comprising comparing means which are designed to monitor the course of an electrical motor signal, in particular a current or voltage signal, over the movement path of the force application element for the reaching or exceeding of a reference signal, which changes over the movement path of the force application element and to perform an action if the reference signal is reached or exceeded. Preferably, the monitoring means are designed to assign motor signal levels of the electric drive motor of the force application element to a reference signal level of the reference signal for a respective adjustment position of the force application element by means of position-indicating signals along its adjustment path. These signals are preferably determined by integrating the angle of rotation or revolutions of a motor shaft of the drive motor of the force application element or a rotary and/or swivel unit coupled to the motor shaft and transmitting a torque.

### BRIEF DESCRIPTION OF THE DRAWINGS

Further advantages, features and details of the invention can be derived from the following description of preferred exemplary embodiments and from the drawings.

In the following,

FIG. 1 is a schematic view of a (combined) baking and pressing apparatus of a domestic baking device realized according to the idea of the invention,

FIG. 2 is a diagram showing a correlation between the force applied on the first baking plate and the movement path of the first baking plate,

FIG. 3 is a diagram showing the curve of a reference signal over a movement path of the first baking plate and the signal curve of a motor signal, in this case a current consumption of the electric motor for moving the first baking plate.

### DETAILED DESCRIPTION

In the figures, the same elements and elements having the same function are referenced with the same reference numerals.

In FIG. 1, a domestic baking device 1 is partially illustrated. More specifically, a combined baking and pressing apparatus 2 of domestic baking device 1 for baking, pressing (flattening) a dough portion 3, for forming a (flat) flat bread in the case at hand, is illustrated. Additionally, the domestic baking device preferably comprises a capsule-emptying apparatus (not shown) for removing dough portion 3 from a portion capsule. In principle, a portion capsule preferably comprises a tub-like capsule body which is sealed by a lid film, the capsule body being made of plastic or light metal alloys.

Baking and pressing apparatus 2 comprises a first baking plate 4 which is designed as a heating and pressing plate and which is disposed along a vertical V above and parallel to a second baking plate 5 which is also designed as a heating and baking plate in the specific exemplary embodiment. Second baking plate 5 is fixed during the pressing process moving or driving first baking plate 4, translatorically in the case at hand, along a movement path. In order to remove the finished food product, a flat bread in the case at hand, second baking plate 5 can preferably be brought into a tilted position. Additionally or alternatively, it is conceivable to move second baking plate 5 for a loading with dough portion 3, for example translatorically perpendicular to movement path s, namely between a receiving or loading position for a loading with the dough portion and the illustrated baking and pressing position.

Both baking plates 4, 5 are in a baking cavity 6 (baking chamber) preferably having a metallic housing disposed in a housing of domestic baking device 1. In addition or as an alternative to a direct heating (heating plate) of the baking plate, it is conceivable to heat the baking chamber in the form of an oven.

Movement means 7 are assigned to first baking plate 4 in order to move the baking plate between an upper initial position and a lower final position which is moved towards second baking plate 5 along movement path s, in the case at hand along a vertical. Movement means 7 comprise an electric drive motor (not shown) and a gear assigned thereto. In the specific exemplary embodiment, movement means 7 also comprise a spindle drive 8 which is exemplarily and preferably disposed centrally for a translatory movement of the first baking plate along movement path s. Instead of the illustrated spindle drive, other transmission means, for example a toggle level assembly, can also be provided. Ideally, the movement means, the depicted kinematics assembly in the case at hand, further on perform the preferably exclusive guiding of the first baking plate during the movement along the movement path, in the case at hand during the vertical translation. Alternatively, the guiding of the first baking plate can also be realized by means of separate guiding devices, for example at the outer circumference of the first baking plate, said separate guiding devices being preferably dispensed with.

Dough portion 3 is normally positioned as represented by dashed lines and referred to with reference sign 3′, namely centrally in an area under spindle drive 8 in order to reduce transverse forces to a minimum. In case of error, it is conceivable that the dough portion is eccentrically arranged or positioned as referred to with reference sign 3 leading to improperly high forces during the pressing process. Additionally or alternatively, it is conceivable that foreign matters enter the area between baking plates 4, 5 because of a mishandling by the user or that the dough portion is completely or partly frozen. All of these errors result in inadmissibly high forces and thus torques and thus current consumption of the electric motor of the adjusting means for adjusting the first baking plate 4.

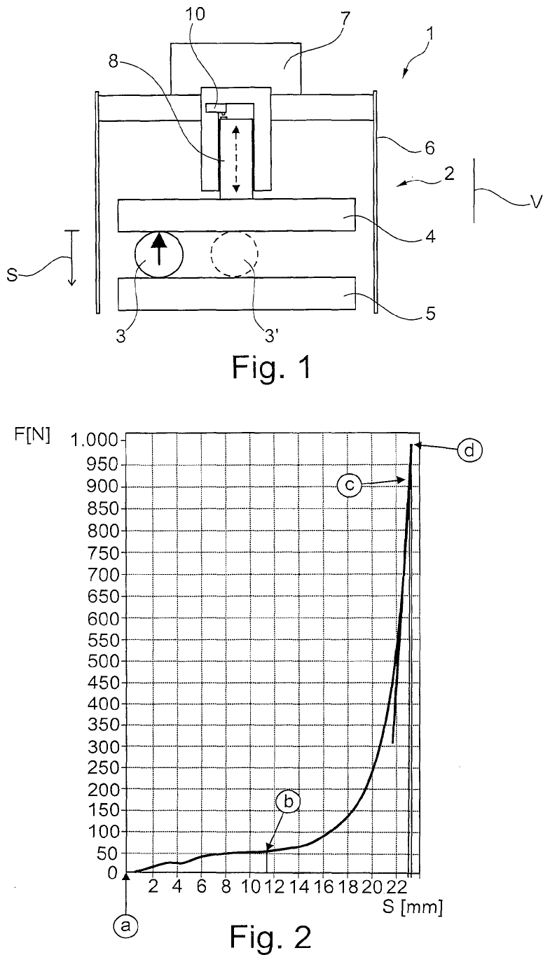

In the diagram according to FIG. 2, a typical force path F over movement path s of first baking plate 4 is illustrated. In the case at hand, the recording of the force path starts at point a at which the first baking plate contacts dough portion 3′. After the compression of the dough portion, in the case at hand by approximately ⅔, the force increases exponentially (after point b). The force path reaches a force maximum at a point at which the dough is pressed flat to a target height (point d). In the illustrated exemplary embodiment, the target height of the dough portion after the pressing process is 1.2 mm. The corresponding force maximum is approximately 1000 N. Point c shows a state shortly before reaching the final movement point (end of the movement path) of the first baking plate.

Significantly higher forces are needed for the flat pressing of frozen doughs. In this case, the force path significantly increases already at the beginning of the flat pressing. If a thawed dough provided by the manufacturer is compressed by 5 mm, for example, the applied force is approximately 30 N. If, in comparison, a frozen dough is compressed by 5 mm, the applied force is in a range of approximately 1000 N. According to the invention, the maximum reference value (reference signal level) for the position would be significantly lower than 1000 N, i.e. at 70 N (30 N multiplied by a safety margin), for example. If, therefore, a frozen dough was conveyed onto second (lower) baking plate 5 and was flat pressed by means of the first baking plate, an error message in the control software of the monitoring means would be output when exceeding a motor signal, in particular the current consumption for generating 70 N pressing force. In reaction of the control software to said error message, the electric motor for driving the first baking plate may be stopped. If, in comparison, an error message was output when exceeding the current consumption for generating 1000 N pressing force, the resulting overload would be significantly higher. This is avoided according to the invention.

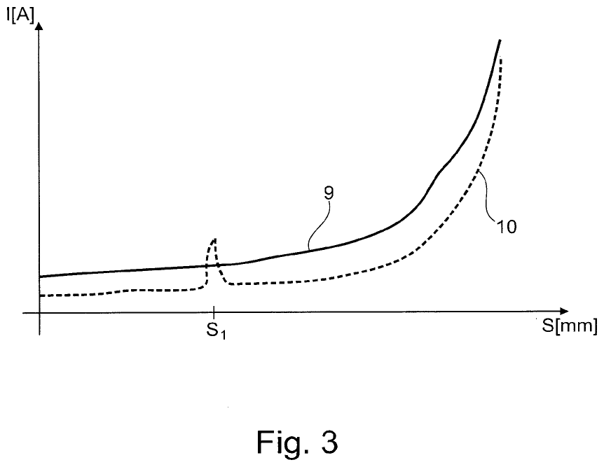

In the exemplary embodiment according to FIG. 1, the motor shaft or a gear wheel or another rotating component of the spindle drive is assigned a non-illustrated rotation angle encoder detecting the angles of rotation of the rotating component and which are added or integrated by non-illustrated monitoring means comprising a microcontroller in the case at hand that is connected to the encoder in a signal-conducting manner, so that a movement position of the first baking plate along the exemplary translatory movement path s can be inferred. A reference signal level of a reference signal 9 (cf. FIG. 3) is assigned to any movement position of the first baking plate along its movement path s. Reference signal 9 thus refers to a limit value signal which signal curve is plotted over the movement path s of the first baking plate. A current consumption I is provided as a reference signal in the case at hand. Over the movement path s a motor signal 10 provided to the monitoring means, a current consumption signal in the present case, is compared with the reference signal 9—thus a comparison of the motor signal curve 10 over the movement path s with the reference signal curve 9 over the movement path s results. Only as an example, motor signal 10 exceeds reference signal 9 at a movement path position S₁. Thus the motor current consumption at this point is too high compared to the reference signal 9, whereby the monitoring means detect a fault which may be caused, for example, by the first baking plate being moved against an eccentrically positioned dough portion, against an impermissible object, or against a completely or partially frozen dough portion. Subsequently, the monitoring means trigger an action, such as stopping and/or returning the first baking plate to its starting position in an (upper) starting position. Before a movement, in particular before any movement of the first baking plate, an initialization takes place, for example by actuating a microswitch 11 (see FIG. 1) in or shortly after the starting position, whereby alternative initialization options can of course also be implemented.

### REFERENCE SIGNS

1 domestic baking device
2 baking and pressing apparatus
3, 3′ dough portion
4 first baking plate
5 second baking plate
6 baking chamber
7 movement means
8 spindle drive
9 reference signal
10 motor signal
11 micro switch
s movement path
I current consumption
V vertical

1-16. (canceled)

17. A domestic baking device for baking a food product, in particular a flat bread, from a dough portion initially held in a portion capsule, the domestic baking device comprising a baking and pressing apparatus (2) for baking and pressing the dough portion (3, 3′), between a first and a second baking plate (5), at least the first baking plate (4) being drivable relative to the second baking plate (5) for a pressing flattening of the dough portion (3, 3′) between the baking plates (4, 5) by means of movement means (7) comprising an electric motor along a movement path (s) towards the second baking plate (5), wherein monitoring means for monitoring the pressing process of the dough portion (3, 3′) are associated with the baking and pressing apparatus (2), the monitoring means comprising comparing means, wherein the comparing means are designed to monitor the curve of an electrical motor signal (10), over the movement path (s) of the first baking plate (4) for the reaching or exceeding of a reference signal (9), which changes over the movement path (s) of the first baking plate (4), and to perform an action if the reference signal (9) is reached or exceeded, the monitoring means being configured in such a manner that the action is or comprises putting out a warning signal, and/or that the action is or comprises stopping or slowing down the movement of the first baking plate (4) towards the second baking plate (5) and/or returning the first baking plate (4) to an initial position,
wherein a memory in which the reference signal levels are stored with the associated position information is associated to the monitoring means,
the monitoring means being configured to assign a reference signal level of the reference signal (9) with motor signal levels of the motor signal (10) via signals indicative of a respective movement position of the first baking plate (4) along the movement path (s) and
the reference signal levels increasing along the movement path (s) of the first baking plate (4) towards the second baking plate (5).

18. The domestic baking device according to claim 17, wherein the monitoring means are configured to determine the signals indicative of the position by integrating rotation angles or rotations of a motor shaft of the electric motor or of a rotating and/or pivoting unit coupled with the motor shaft of the electric motor to transmit a torque.

19. The domestic baking device according to claim 18, wherein initialization means for setting an initial position for the integration are associated to the monitoring means.

20. The domestic baking device according to claim 17, wherein the first baking plate (4) is disposed along the vertical above the second baking plate (5) if the domestic baking device (1) is supported on a horizontal supporting surface and/or wherein the first baking plate is disposed parallel to the second baking plate (5) during the movement.

21. The domestic baking device according to claim 17, wherein the domestic baking device (1) comprising a capsule-emptying-apparatus for removing the dough portion (3, 3′) from a portion capsule, the capsule-emptying apparatus having a plunger being adjustable relative to a capsule support for applying force to, the capsule and/or comprising a holding-down stamp being drivable by means of an electric motor.

22. The domestic baking device according to claim 17, wherein the movement means (7) comprise a transmission device, for guiding the first baking plate (4) along the movement path (s) during its movement.

23. A method for operating a domestic baking device (1) according to claim 17, for baking a food product, in particular a flat bread, from a dough portion (3, 3′) from a portion capsule, the first baking plate (4) being driven by the electric motor for a pressing flattening of the dough portion (3, 3′) disposed between the baking plates (4, 5) along the movement path (s) towards the second baking plate (5), wherein a curve of an electrical motor signal (10), over the movement path (s) of the first baking plate (4) is monitored for the reaching or exceeding of a reference signal (9), which changes over the movement path (s) of the first baking plate (4), and, if the reference signal (9) is reached or exceeded, an action is performed by monitoring means in such a manner that as the action, a warning signal, is output and/or the movement of the first baking plate (4) towards the second baking plate (5) is stopped or slowed down and/or the first baking plate (4) is returned to the initial position through corresponding driving of the electric motor,
wherein in order to monitor the curve of the electrical motor signal (10) during the movement motor signal levels are compared to reference signal levels, which are stored in a memory, wherein the motor signal levels and reference signal levels to be compared are assigned via signals indicative of the position of respective movement positions of the first baking plate (4) along the movement path (s), and wherein the reference signal levels increase along the movement path (s) of the first baking plate (4) towards the second baking plate (5).

24. The method according to claim 23, wherein the signals indicative of the position are determined by integrating rotation angles or rotations of a motor shaft or of a rotating or pivoting unit coupled with the motor shaft to transmit a torque, in particular a gear wheel or a spindle or a spindle nut or a lever arm.

25. The method according to claim 24, wherein a sensor for detecting the rotation angles and/or rotations is initialized prior to the integration to define an initial position of the first baking plate (4).

26. The domestic baking device according to claim 17, wherein the movement path is a straight movement path.

27. The domestic baking device according to claim 17, wherein the electric motor signal is a current or voltage signal.

28. The domestic baking device according to claim 17, wherein the warning signal is a visual and/or acoustic and/or haptic warning signal.

29. The domestic baking device according to claim 28, wherein the rotating and/or pivoting unit is a gear wear or a spindle or a spindle nut or a lever arm.

30. The domestic baking device according to claim 21, wherein the plunger is adjustable relative to the capsule support for deforming the capsule.

31. The domestic baking device according to claim 22, wherein the movement means comprises a single transmission device.

32. The domestic baking device according to claim 22, wherein the transmission device comprises a spindle drive (8).

33. The domestic baking device according to claim 32, wherein the spindle drive omits guiding devices acting at the outer circumference of the first baking plate (4) for guiding the first baking plate (4) along the movement path(s) during its movement.

34. The method according to claim 23, wherein the electric motor signal is a current or voltage signal.

35. The method according to claim 23, wherein the warning signal is a visual and/or acoustic and/or haptic warning signal.

36. The method according to claim 24, wherein the rotating or pivoting unit is a gear wear or a spindle or a spindle nut or a lever arm.
